(19) United States
(12) Patent Application Publication
(10) Pub. No.: US 2010/0254889 A1
(43) Pub. Date: Oct. 7, 2010

(54) METHOD FOR PRODUCING SULFURIC ACID

(75) Inventors: Thomas Bogenstätter, Bad Durkheim (DE); Jörg Torsten Nickel, Karlsruhe (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/741,089

(22) PCT Filed: Nov. 6, 2008
(86) PCT No.: PCT/EP2008/065044

§ 371 Date: May 3, 2010

(30) Foreign Application Priority Data
Nov. 7, 2007 (EP) 07120139.6

(51) Int. Cl. C01B 17/765

(52) U.S. Cl. 423/522

(57) ABSTRACT

A process for preparing sulfuric acid, in which process gases comprising sulfur dioxide are obtained by combustion of liquid sulfur by means of process air introduced from the outside or by dissociation of waste sulfuric acids and the sulfur dioxide in the process gases comprising sulfur dioxide is oxidized to sulfur trioxide and converted into sulfuric acid by the contact process, wherein the process air which is introduced from the outside for combustion of sulfur or the process gases comprising sulfur dioxide which are obtained by dissociation of waste sulfuric acid have their water vapor content reduced by cooling them, is proposed.

The invention relates to a process for preparing sulfuric acid by the contact process.

Sulfuric acid is one of the basic products of the chemical industry. Sulfuric acid is prepared from sulfur dioxide which is oxidized to sulfur trioxide. The latter is reacted with water in concentrated sulfuric acid to produce sulfuric acid.

The sulfur dioxide is largely obtained by combustion of elemental sulfur, but also from waste sulfuric acids by dissociation thereof.

The combustion of elemental sulfur with atmospheric oxygen to give sulfur dioxide is strongly exothermic:

S+O₂→S)₂(ΔH=−297 kJ/mol)

It is carried out industrially in combustion furnaces using atomization burners for liquid sulfur, using dried air as oxidant. Liquid sulfur at 140-150° C. is sprayed in finely divided droplet form into combustion chambers by means of nozzles. The concentration of sulfur dioxide in the gas mixture leaving the chambers is usually adjusted by means of air to 9-11.5% by volume; the oxygen present in the gas mixture is sufficient for the subsequent production of sulfur trioxide. The hot gases are then cooled to about 450° C. by means of a waste heat boiler in which steam is generated. A purification operation is not necessary (cf. K. H. Büchel et al.: Industrielle Anorganische Chemie, 3rd edition, Verlag Chemie, Weinheim 1999, pp. 110-122).

As an alternative, sulfur dioxide can also be recovered from waste sulfuric acids by dissociation thereof. Contaminated sulfuric acids are obtained in many processes, especially in organic chemistry, petrochemistry and the metals industry. The most reliable way of avoiding waste problems and possible environmental pollution is thermal dissociation to form sulfur dioxide according to the following reaction equation:

2H₂SO₄→2SO₂+O₂+2H₂O

and subsequent conversion of the sulfur dioxide into sulfuric acid, which can be used further.

The oxidation of sulfur dioxide to sulfur trioxide and conversion of the latter into sulfuric acid is nowadays carried out virtually exclusively by the contact process, in particular the double contact process. The contact process for the oxidation of sulfur dioxide is based on the equilibrium

$${SO}_{2} + \frac{1}{2} {O}_{2} ⇄ {SO}_{3} ( Δ H = - 99.0 kJ \text{/} mol ) ;$$

it is established sufficiently quickly only in the presence of a catalyst. Since it shifts in the direction of the starting materials with increasing temperature, it has to be carried out at the lowest possible temperature, with the lower temperature limit being determined by the operating temperature of the catalyst. A higher sulfur dioxide conversion can be achieved by reducing the concentration of the sulfur trioxide formed (double contact process) or by working under an increased pressure (5 bar) (Ugine-Kuhlmann process). As catalysts, use is nowadays made virtually exclusively of copper-bismuth catalysts industry.

The conversion of sulfur trioxide into sulfuric acid,

SO₃+H₂O→H₂SO₄(ΔH=−132 kJ/mol)

is carried out by dissolving sulfur trioxide in concentrated sulfuric acid while evenly adding water or low-concentration sulfuric acid.

Sulfuric acid is used in many ways as one of the key products of the chemical industry. An important field of use is increasing the concentration of azeotropic nitric acid, i.e. nitric acid having a concentration in the region of the azeotropic composition of about 68% of nitric acid, to produce concentrated nitric acid having a nitric acid content of up to 100%. Concentrated nitric acid is required, for example, for the preparation of dinitrotoluene. In this process, it is advantageous to use highly concentrated sulfuric acid comprising over 86% by weight of sulfuric acid or else fresh sulfuric acid having a concentration of over 95% by weight in order to avoid energy-intensive concentration by distillation of dilute sulfuric acid obtained in the process of increasing the concentration of nitric acid.

It was therefore an object of the invention to reduce the introduction of water in the process for preparing sulfuric acid.

This object is achieved by a process for preparing sulfuric acid, in which process gases comprising sulfur dioxide are obtained by combustion of liquid sulfur by means of process air introduced from the outside or by dissociation of waste sulfuric acids and the sulfur dioxide in the process gases comprising sulfur dioxide is oxidized to sulfur trioxide and converted into sulfuric acid by the contact process, wherein the process air which is introduced from the outside for combustion of sulfur or the process gases comprising sulfur dioxide which are obtained by dissociation of waste sulfuric acid have their water vapor content reduced by cooling them.

In one embodiment, the process air from the outside for combustion of liquid sulfur is conveyed via a compressor. It is advantageous to reduce the water vapor content of the process air for combustion of liquid sulfur by cooling it before it is fed to the compressor. This not only has a positive influence on the water balance of the process but also makes the process more energetically favorable because the compressor compresses cooler air and thus uses less energy for thermodynamic reasons.

The process air for the combustion of liquid sulfur or the process gases comprising sulfur dioxide which are obtained by dissociation of waste sulfuric acids are, in a preferred embodiment of the invention, cooled by direct contact with a cooling medium.

As cooling medium, it is advantageous to use water having a temperature in the range from 1 to 10° C. or sulfuric acid having a temperature in the range from −5 to +10° C., or brine.

In a further preferred embodiment, the process air for the combustion of liquid sulfur or the process gases comprising sulfur dioxide which are obtained by dissociation of waste sulfuric acids can be cooled by indirect cooling using a cooling medium.

The indirect cooling can advantageously be carried out by means of a commercial air conditioning unit.

The extent to which the water vapor content has to be reduced by cooling is decided in the individual case by a person skilled in the art on the basis of economic aspects, taking into account, in particular, the humidity of the air at the location at which the process is used and the desired concentration of the sulfuric acid to be produced. The process air introduced from the outside for the combustion of sulfur or the process gases comprising sulfur dioxide can advantageously be cooled to a temperature below 5° C.

The water vapor content of the process air for the combustion of liquid sulfur or the process gases comprising sulfur dioxide which are formed by dissociation of waste sulfuric acids can preferably be reduced to below 1% by volume.

The process of the invention has the advantage that it reduces the introduction of water into processes for preparing sulfuric acid in a manner which is simple to realize in industry.

Furthermore, the energy costs for the compressor for the process air are reduced by the use of precooled process air. As a result of the treatment according to the invention of process gases comprising sulfur dioxide from dissociated sulfuric acids, more dilute and thus cheaper sulfuric acid can be used in processes for increasing the concentration of nitric acids.

The invention is illustrated below with the aid of a drawing.

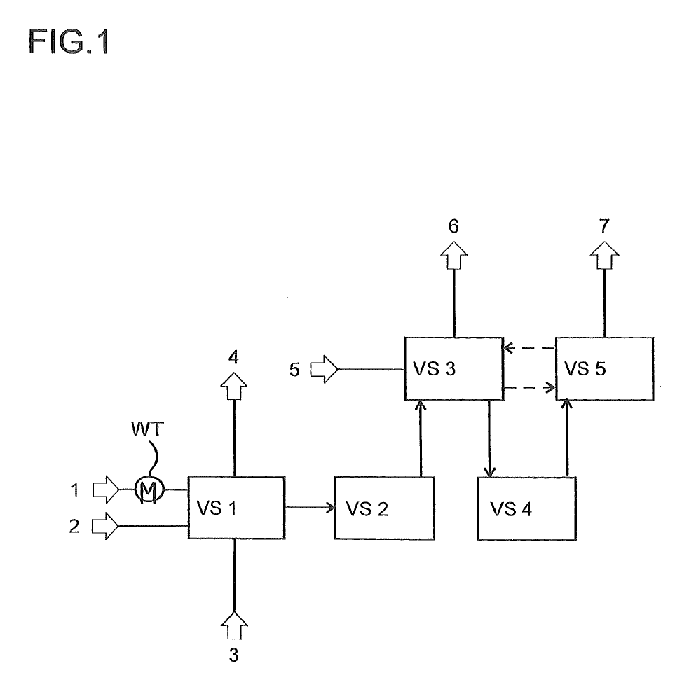

FIG. 1 shows a flow diagram of a sulfuric acid plant according to the invention which uses the double contact process and

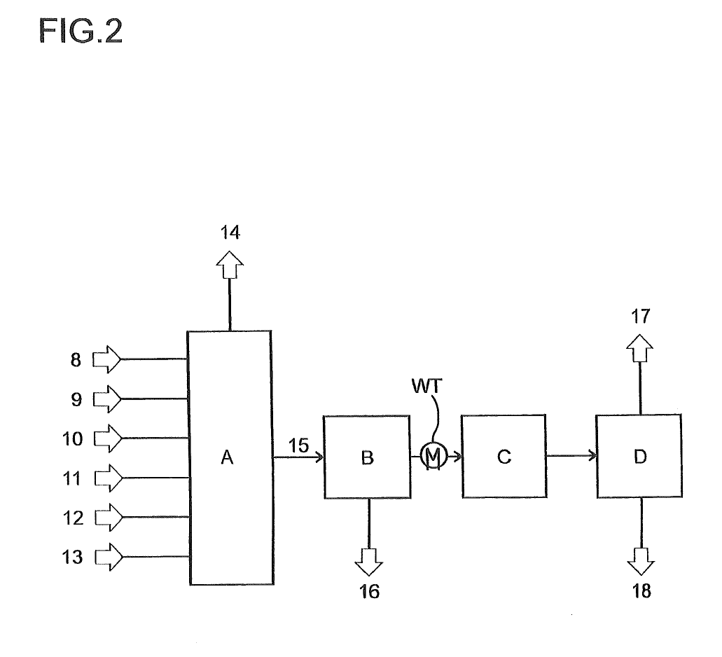

FIG. 2 shows a flow diagram of a plant according to the invention using dissociated sulfuric acid.

In the plant shown in FIG. 1, air, stream 1, is, according to the invention, fed via a heat exchanger WT to a combustion plant VS1 for liquid sulfur, stream 2. A major part of the energy liberated during combustion is utilized for cooling the combustion gas so as to raise steam by converting feed water, stream 3, into steam, stream 4.

The reaction mixture from the sulfur combustion unit VS1 is fed to a first process stage, VS2, of the double contact process which has an efficiency of about 95%. In the third process stage, VS3, sulfuric acid and oleum, stream 6, are produced. Here, sulfur trioxide is dissolved in concentrated sulfuric acid with constant addition of water, stream 5. The concentration of the oleum is kept constant by continuous addition of sulfuric acid.

Process stage VS4 is the second stage of the catalytic oxidation of sulfur dioxide by means of atmospheric oxygen to form sulfur trioxide by the double contact process. The removal of sulfur trioxide from the chemical equlibrium in process stage VS3 aids the conversion of the remaining about 5% of sulfur dioxide in process stage VS4. The total conversion in process stages VS2 and VS4, i.e. the first and second stages of the double contact process, is more than 99.7%.

In a manner analogous to the intermediate absorber in process stage VS3, sulfuric acid is prepared by absorption of the sulfur trioxide formed in process stage VS4 in the final absorber, VS5. The offgas leaving the final absorber VS5, stream 7, consists

1-8. (canceled)

9. A process for preparing sulfuric acid, in which process gases comprising sulfur dioxide are obtained by combustion of liquid sulfur by means of process air introduced from the outside and the sulfur dioxide in the process gases comprising sulfur dioxide is oxidized to sulfur trioxide and converted into sulfuric acid by the contact process, wherein the process air which is introduced from the outside for combustion of sulfur has their water vapor content reduced by cooling it.

10. The process according to claim 9, in which the process air from the outside for combustion of liquid sulfur is conveyed via a compressor, wherein the process air has its water vapor content reduced by cooling it before being fed to the compressor.

11. The process according to claim 9, wherein the process air for the combustion of liquid sulfur are cooled by direct contact with a cooling medium.

12. The process according to claim 11, wherein water having a temperature in the range from 1 to 10° C. or sulfuric acid having a temperature in the range from −5 to +10° C. or brine is used as cooling medium.

13. The process according to claim 9, wherein the process air for the combustion of liquid sulfur are cooled by indirect cooling using a cooling medium.

14. The process according to claim 13, wherein the indirect cooling is carried out by means of a commercial air conditioning unit.

15. The process according to claim 9, wherein cooling is carried out to temperatures below 5° C.

16. The process according to claim 9, wherein the water vapor content of the process air which is introduced from the outside for combustion of sulfur is reduced to less than 1% by volume.
